(19) United States
(12) Patent Application Publication
(10) Pub. No.: US 2018/0089519 A1
(43) Pub. Date: Mar. 29, 2018

(54) MULTI-MODAL USER AUTHENTICATION

(71) Applicants: Michael Raziel, Jerusalem (IL); Alex Nayshtut, Gan Yavne (IL); Oleg Pogorelik, Lapid (IL); Amit Bleiweiss, Yad Binyamin (IL); Eliyahu Elhadad, Kidron (IL)

(72) Inventors: Michael Raziel, Jerusalem (IL); Alex Nayshtut, Gan Yavne (IL); Oleg Pogorelik, Lapid (IL); Amit Bleiweiss, Yad Binyamin (IL); Eliyahu Elhadad, Kidron (IL)

(21) Appl. No.: 15/275,797

(22) Filed: Sep. 26, 2016

(51) Int. Cl. G06K 9/00; G06F 3/01; G06T 15/08; G06F 21/32; G06F 21/45

(52) U.S. Cl. CPC G06K 9/00892; G06F 3/017; G06F 21/45; G06F 21/32; G06T 15/08

(57) ABSTRACT

Various systems and methods for providing a mechanism for multi-modal user authentication are described herein. An authentication system for multi-modal user authentication includes a memory including image data captured by a camera array, the image data including a hand of a user; and an image processor to: determine a hand geometry of the hand based on the image data; determine a palm print of the hand based on the image data; determine a gesture performed by the hand based on the image data; and determine a bio-behavioral movement sequence performed by the hand based on the image data; and an authentication module to construct a user biometric template using the hand geometry, palm print, gesture, and bio-behavioral movement sequence.

### TECHNICAL FIELD

Embodiments described herein generally relate to computer security and in particular, to multi-modal user authentication.

### BACKGROUND

Multi-factor authentication (MFA) is a scheme for controlling access to a secured resource, such as a computer, online account, or a server room. Using MFA, a user is only granted access after presenting separate pieces of identification evidence to an authentication system. MFA may be two-factor (e.g., requiring two pieces of information), three-factor, or more. Factors are conventionally broken out into rough categories of knowledge, possession, and inherence. In other words, factors are representative of what one knows (knowledge), what one has (possession), or what one is (inherence). Examples of knowledge factors include usernames, passwords, or personal identification numbers (PINs); and examples of possession factors include a pass card or an RFID tag; examples of inherence factors include fingerprints, retinal scans, or other biometric data.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating control and data flow, according to an embodiment;

FIG. 2 is a block diagram illustrating an authentication system, according to an embodiment;

FIG. 3 is a block diagram illustrating an authentication system for multi-modal user authentication, according to an embodiment;

FIG. 4 is a flowchart illustrating a method for multi-modal user authentication, according to an embodiment; and

FIG. 5 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Disclosed herein are systems and methods that provide multi-modal user authentication. Similar to multi-factor authentication, multi-modal authentication uses several pieces of information to authenticate a person. The multi-modal mechanism described in this document enhances the authentication procedure, simplifying it, and making it more intuitive for a user. The multi-modal authentication mechanism includes at least four different biometrical factors: hand geometry, palm print, user gesture, and a bio-behavioral movement.

FIG. 1 is a schematic drawing illustrating control and data flow 100, according to an embodiment. A user's hand and arm motion is captured (phase 102). The hand/arm motion is analyzed to obtain and measure four independent biometrical factors: hand geometry, palm print, user gesture, and a bio-behavioral movement (phase 104). Hand geometry may refer to various measurements of the hand and wrist. Example measurements used in the hand geometry metric include, but are not limited to finger length, finger width, finger thickness, volume or surface area of portions of the hand, distance between fingers or finger bases, size of the palm, wrist-to-fingertip measurement, the size of the hand, and the like.

Palm print may refer to various measurements of a palm or adjacent biological features. Examples of measurements used in a palm print include, but are not limited to the length, size, or state of creases in the palm lines—such as the direction, orientation, location of the creases—and other features of interest points of the palm.

The user gesture is a gesture consciously performed by the user. The user gesture may be performed in response to a prompt. For example, the authentication system may prompt the user to perform a predefined gesture, such as one that the user had previously recorded for authentication purposes. The gesture may include one or more distinct hand, arm, wrist, or body positions, either statically posed or a series of movements (e.g., a gesture that includes motion).

The bio-behavioral movement reflects subconscious movement by the user. Movement rhythm, movement of the hand in 3D space, or other movements that describe unique palm, hand, wrist, or arm motions may be tracked. For instance, the way a person brushes her hair from her face, or the way a person adjusts his tie, or the way that a person types on a keyboard or holds a mouse, may be distinctive and may be used to determine identity or for authentication.

The factors are matched with predefined patterns, which may be stored in a protected storage device (phase 106). The factor matching (phase 106) may be performed in a trusted execution environment (TEE) and may be enforced with various management policies. Policies may be used to weight one or more of the factors higher or lower than other factors. Policies may also be used to provide the confidence required to allow access to the secured resource.

The authentication mechanism described herein provides a low cost solution by replacing multiple dedicated hardware components with fewer general purpose components. It also improves the user experience where the user does not have to touch anything. Instead, hand geometries, palm prints, and other factors are captured using a camera system. The authentication mechanism may provide increased security because the bio-behavioral component is especially difficult to spoof. The use of four factors also increases the reliability of the authentication decision. For at least these reasons, the present authentication mechanism provides various improvements over the existing authentication mechanisms.

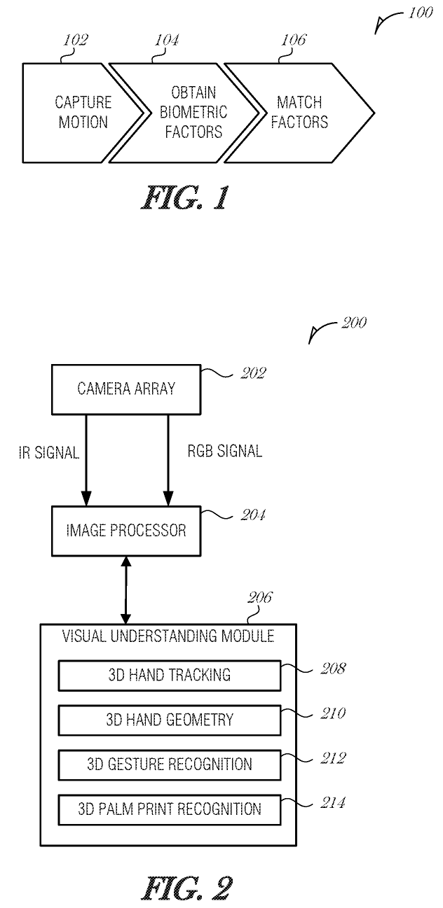

FIG. 2 is a block diagram illustrating an authentication system 200, according to an embodiment. The authentication system 200 includes a camera array 202 that provides images to an image processor 204. The image processor 204 may sync the signals from cameras in the camera array 202, such as a visible light camera (e.g., RGB camera) and an infrared (IR) camera. The camera array 202 may include more or fewer devices than an RGB and IR camera, such as an IR laser projector. Additionally, the camera array 202 may include multiples of a type of camera, for example two IR cameras. The signals from the multiple cameras may be fused and processed by the image processor 204 to calibrate and transform raw input according to spatial information, such as distance to, angle of, inclination of, or orientation of the hand in an image frame.

Image data may be provided to one or more computer vision algorithms operating in a visual understanding module (VUM) 206. The VUM 206 may extract features of the hand or palm and perform one or more functions on the extracted features. The computer vision algorithms may be used to perform the functions of 3D hand tracking 208, 3D hand geometry extraction 210, 3D gesture recognition 212, and 3D palm print recognition 214. Using the four aspects, a user template is constructed and stored.

The VUM 206 may work with a user interface (not shown) to prompt the user to perform actions, repeat an action, or otherwise instruct or inform the user. The user interface may be a graphical user interface, such as one that is displayed on a monitor, or other types of user interfaces, such as an audio user interface (e.g., spoken commands).

3D hand tracking 208 may be performed by monitoring the user's hand over a period of time. The image of the hand may be transformed to a point cloud, skeletonized, or otherwise transformed so that discrete points or areas of the hand may be tracked through 3D space. For example, fingertips may be extracted from the hand image and tracked in space over time. As another example, a skeletonized model may be extracted and modeled over time to determine recurring motions, hand or finger positions, or other aspects of the user's subconscious hand behavior. The 3D hand tracking 208 may be initiated when a person is first detected in front of the camera array 202. For example, when the person first sits down at the computer, the person's hand or hands may be tracked and analyzed for bio-behavioral motion. As another example, as a person approaches a secured door, the person's hands may be tracked. In this manner, the person may be unaware of the bio-behavioral hand tracking as being a part of the authentication mechanism, resulting in a more intuitive and seamless interaction.

3D hand geometry 210 may be performed on one or more images captured as the person moves their hand or hands in front of the camera array 202. For example, when the person is prompted to perform a gesture for authentication, the person's hand may be captured and the 3D hand geometry 210 may be performed. 3D hand geometry 210 includes measuring various features of the person's hand or hands, and possibly adjacent features, such as the person's wrist. Using multiple images of the hand, finger size, wrist size, or other features of the hand may be captured and measured to determine 3D hand geometry 210.

3D gesture recognition 212 may be performed when a person is prompted to perform the gesture. For example, the person may be prompted to authenticate themselves by performing the authentication gesture. The resulting movement may be captured using one or more images. The gesture may be compared to a repository of gestures to determine whether the gesture is recognized. Gesture recognition may be performed by transforming a point cloud of the hand using an optimization scheme to match a corresponding synthetic 3D model of the hand. Gesture recognition may alternatively be performed using machine learning. For example, one or more clips of hand motion from a variety of people may be captured and used as input into a convolutional neural network (CNN). The output of the CNN would be a classifier able to differentiate between different gestures, treating each gesture as a separate weight in the topology.

3D palm print recognition 214 may be performed by capturing one or more images of the person's palm and extracting palm print features. Palm print features are made up of palm lines, principal lines and creases state. Information may include the location, direction, and orientation of each interest point. Palm matching techniques include minutiae-based matching, correlation-based matching, and ridge-based matching.

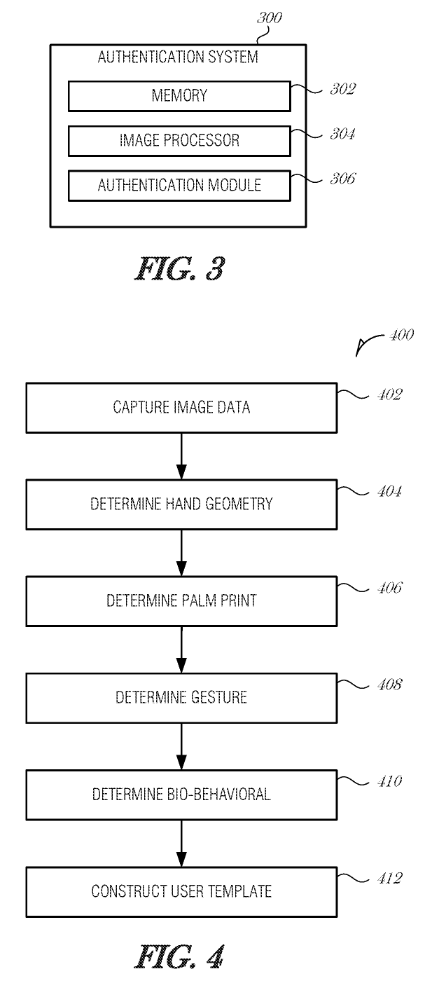

FIG. 3 is a block diagram illustrating an authentication system 300 for multi-modal user authentication, according to an embodiment. The authentication system 300 includes a memory 302, an image processor 304, and an authentication module 306. The memory 302 includes image data captured by a camera array, the image data including a hand of a user. In an embodiment, the image data includes a composition of infrared imagery and visible light imagery. In a related embodiment, the camera array comprises an infrared camera and a visible light camera, and the infrared imagery and visible light imagery of the image data are synchronized in the time and space domain.

The image processor 304 may be configured to access the image data, determine a hand geometry of the hand based on the image data, determine a palm print of the hand based on the image data, determine a gesture performed by the hand based on the image data, and determine a bio-behavioral movement sequence performed by the hand based on the image data.

Using this information, the authentication module 306 may be configured to construct a user biometric template using the hand geometry, palm print, gesture, and bio-behavioral movement sequence. In an embodiment, the authentication module 306 is to use the user biometric template to authenticate the user, for instance by prompting the user at a later time to perform the gesture and obtaining images of the user's hand to identify and extract the various biometric features to compare with the user biometric template.

In an embodiment, to determine the hand geometry, the image processor 304 is to obtain a first and second feature of the hand and measure a distance from the first feature to the second feature. In a further embodiment, the first feature is a base of a first finger and the second feature is a base of second finger of the hand. In a related embodiment, the first feature is a base of a finger and the second feature is a tip of the finger.

In an embodiment, to determine the hand geometry, the image processor 304 is to create a three-dimensional model of the hand based on a plurality of images from the image data and estimate a volume of at least a portion of the three-dimensional model of the hand, wherein the hand geometry includes the volume. In a further embodiment, the volume is a volume of a finger of the hand. In a related embodiment, the volume is a volume of the entire hand.

In an embodiment, to determine the palm print, the image processor 304 is to identify a palm portion of the hand, identify a crease in the palm portion, and capture a shape defined by the crease.

In an embodiment, to determine the gesture performed by the hand, the image processor 304 is to obtain a movement of the hand over time using a series of images from the image data and use a classifier to differentiate the movement and identify the gesture.

In an embodiment, to determine the bio-behavioral movement sequence performed by the hand, the image processor 304 is to access a series of images from the image data, the series of images depicting movement over time of the hand, identify a pattern of behavior exhibited in the series of images, and store the pattern as the bio-behavioral movement sequence. In a further embodiment, the pattern of behavior comprises subconscious movement performed by the user.

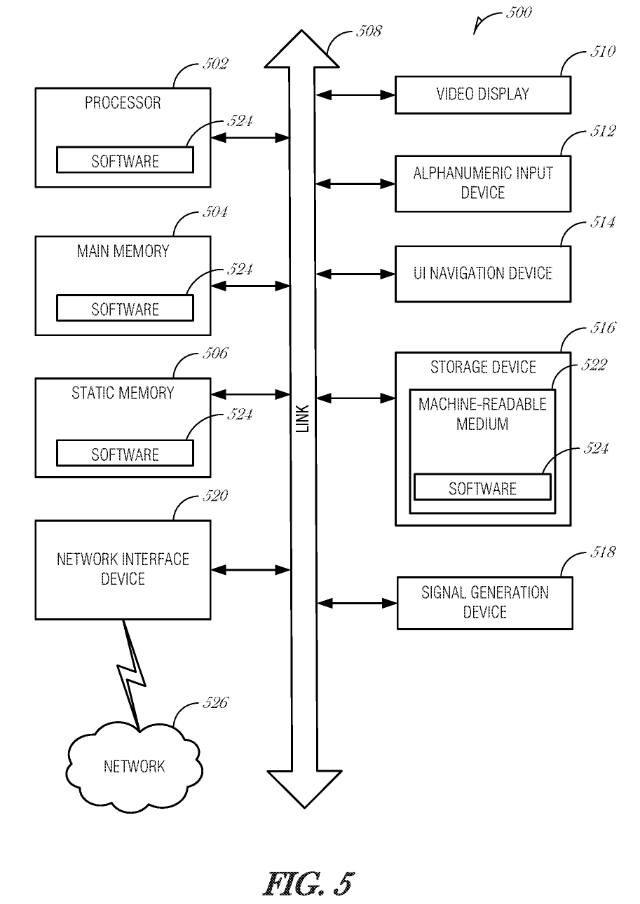

FIG. 4 is a flowchart illustrating a method 400 for multi-modal user authentication, according to an embodiment. At 402, image data captured by a camera array is accessed, where the image data includes a hand of a user. In an embodiment, the image data includes a composition of infrared imagery and visible light imagery. In another embodiment, the camera array comprises an infrared camera and a visible light camera, and wherein the infrared imagery and visible light imagery of the image data are synchronized in the time and space domain.

At 404, a hand geometry of the hand is determined based on the image data. In an embodiment, determining the hand geometry comprises obtaining a first and second feature of the hand and measuring a distance from the first feature to the second feature. In a further embodiment, the first feature is a base of a first finger and the second feature is a base of second finger of the hand. In a related embodiment, the first feature is a base of a finger and the second feature is a tip of the finger.

In an embodiment, determining the hand geometry comprises creating a three-dimensional model of the hand based on a plurality of images from the image data and estimating a volume of at least a portion of the three-dimensional model of the hand, wherein the hand geometry includes the volume. In a further embodiment, the volume is a volume of a finger of the hand. In a related embodiment, the volume is a volume of the entire hand.

At 406, a palm print of the hand is determined based on the image data. In an embodiment, determining the palm print comprises identifying a palm portion of the hand, identifying a crease in the palm portion, and capturing a shape defined by the crease.

At 408, a gesture performed by the hand is determined based on the image data. In an embodiment, determining the gesture performed by the hand comprises obtaining a movement of the hand over time using a series of images from the image data and using a classifier to differentiate the movement and identify the gesture.

At 410, a bio-behavioral movement sequence performed by the hand is determined based on the image data. In an embodiment, determining the bio-behavioral movement sequence performed by the hand comprises accessing a series of images from the image data, the series of images depicting movement over time of the hand, identifying a pattern of behavior exhibited in the series of images, and storing the pattern as the bio-behavioral movement sequence. In a further embodiment, the pattern of behavior comprises subconscious movement performed by the user.

At 412, a user biometric template is constructed using the hand geometry, palm print, gesture, and bio-behavioral movement sequence. In an embodiment, the method 400 includes using the user biometric template to authenticate the user. For instance, the user may be prompted to perform the previously-performed gesture, during which the camera array may capture images of the user's hand to identify and extract the various biometric features related to the user template.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is an authentication system for multi-modal user authentication, the system comprising: a memory including image data captured by a camera array, the image data including a hand of a user; and an image processor to: determine a hand geometry of the hand based on the image data; determine a palm print of the hand based on the image data; determine a gesture performed by the hand based on the image data; and determine a bio-behavioral movement sequence performed by the hand based on the image data; and an authentication module to construct a user biometric template using the hand geometry, palm print, gesture, and bio-behavioral movement sequence.

In Example 2, the subject matter of Example 1 optionally includes wherein the image data includes a composition of infrared imagery and visible light imagery.

In Example 3, the subject matter of any one or more of Examples 1-2 optionally include wherein the camera array comprises an infrared camera and a visible light camera, and wherein the infrared imagery and visible light imagery of the image data are synchronized in the time and space domain.

In Example 4, the subject matter of any one or more of Examples 1-3 optionally include wherein to determine the hand geometry, the image processor is to: obtain a first and second feature of the hand; and measure a distance from the first feature to the second feature.

In Example 5, the subject matter of Example 4 optionally includes wherein the first feature is a base of a first finger and the second feature is a base of second finger of the hand.

In Example 6, the subject matter of any one or more of Examples 4-5 optionally include wherein the first feature is a base of a finger and the second feature is a tip of the finger.

In Example 7, the subject matter of any one or more of Examples 1-6 optionally include wherein to determine the hand geometry, the image processor is to: create a three-dimensional model of the hand based on a plurality of images from the image data; and estimate a volume of at least a portion of the three-dimensional model of the hand, wherein the hand geometry includes the volume.

In Example 8, the subject matter of Example 7 optionally includes wherein the volume is a volume of a finger of the hand.

In Example 9, the subject matter of any one or more of Examples 7-8 optionally include wherein the volume is a volume of the entire hand.

In Example 10, the subject matter of any one or more of Examples 1-9 optionally include wherein to determine the palm print, the image processor is to: identify a palm portion of the hand; identify a crease in the palm portion; and capture a shape defined by the crease.

In Example 11, the subject matter of any one or more of Examples 1-10 optionally include wherein to determine the gesture performed by the hand, the image processor is to: obtain a movement of the hand over time using a series of images from the image data; and use a classifier to identify the gesture.

In Example 12, the subject matter of any one or more of Examples 1-11 optionally include wherein to determine the bio-behavioral movement sequence performed by the hand, the image processor is to: access a series of images from the image data, the series of images depicting movement over time of the hand; identify a pattern of behavior exhibited in the series of images; and store the pattern as the bio-behavioral movement sequence.

In Example 13, the subject matter of Example 12 optionally includes wherein the pattern of behavior comprises subconscious movement performed by the user.

In Example 14, the subject matter of any one or more of Examples 1-13 optionally include wherein the authentication module is to use the user biometric template to authenticate the user.

Example 15 is a method of multi-modal user authentication, the method comprising: accessing image data captured by a camera array, the image data including a hand of a user; determining a hand geometry of the hand based on the image data; determining a palm print of the hand based on the image data; determining a gesture performed by the hand based on the image data; determining a bio-behavioral movement sequence performed by the hand based on the image data; and constructing a user biometric template using the hand geometry, palm print, gesture, and bio-behavioral movement sequence.

In Example 16, the subject matter of Example 15 optionally includes wherein the image data includes a composition of infrared imagery and visible light imagery.

In Example 17, the subject matter of any one or more of Examples 15-16 optionally include wherein the camera array comprises an infrared camera and a visible light camera, and wherein the infrared imagery and visible light imagery of the image data are synchronized in the time and space domain.

In Example 18, the subject matter of any one or more of Examples 15-17 optionally include wherein determining the hand geometry comprises: obtaining a first and second feature of the hand; and measuring a distance from the first feature to the second feature.

In Example 19, the subject matter of Example 18 optionally includes wherein the first feature is a base of a first finger and the second feature is a base of second finger of the hand.

In Example 20, the subject matter of any one or more of Examples 18-19 optionally include wherein the first feature is a base of a finger and the second feature is a tip of the finger.

In Example 21, the subject matter of any one or more of Examples 15-20 optionally include wherein determining the hand geometry comprises: creating a three-dimensional model of the hand based on a plurality of images from the image data; and estimating a volume of at least a portion of the three-dimensional model of the hand, wherein the hand geometry includes the volume.

In Example 22, the subject matter of Example 21 optionally includes wherein the volume is a volume of a finger of the hand.

In Example 23, the subject matter of any one or more of Examples 21-22 optionally include wherein the volume is a volume of the entire hand.

In Example 24, the subject matter of any one or more of Examples 15-23 optionally include wherein determining the palm print comprises: identifying a palm portion of the hand; identifying a crease in the palm portion; and capturing a shape defined by the crease.

In Example 25, the subject matter of any one or more of Examples 15-24 optionally include wherein determining the gesture performed by the hand comprises: obtaining a movement of the hand over time using a series of images from the image data; and using a classifier to identify the gesture.

In Example 26, the subject matter of any one or more of Examples 15-25 optionally include wherein determining the bio-behavioral movement sequence performed by the hand comprises: accessing a series of images from the image data, the series of images depicting movement over time of the hand; identifying a pattern of behavior exhibited in the series of images; and storing the pattern as the bio-behavioral movement sequence.

In Example 27, the subject matter of Example 26 optionally includes wherein the pattern of behavior comprises subconscious movement performed by the user.

In Example 28, the subject matter of any one or more of Examples 15-27 optionally include using the user biometric template to authenticate the user.

Example 29 is at least one machine-readable medium including instructions, which when executed by a machine, cause the machine to perform operations of any of the methods of Examples 15-28.

Example 30 is an apparatus comprising means for performing any of the methods of Examples 15-28.

Example 31 is an apparatus for multi-modal user authentication, the apparatus comprising: means for accessing image data captured by a camera array, the image data including a hand of a user; means for determining a hand geometry of the hand based on the image data; means for determining a palm print of the hand based on the image data; means for determining a gesture performed by the hand based on the image data; means for determining a bio-behavioral movement sequence performed by the hand based on the image data; and means for constructing a user biometric template using the hand geometry, palm print, gesture, and bio-behavioral movement sequence.

In Example 32, the subject matter of Example 31 optionally includes wherein the image data includes a composition of infrared imagery and visible light imagery.

In Example 33, the subject matter of any one or more of Examples 31-32 optionally include wherein the camera array comprises an infrared camera and a visible light camera, and wherein the infrared imagery and visible light imagery of the image data are synchronized in the time and space domain.

In Example 34, the subject matter of any one or more of Examples 31-33 optionally include wherein the means for determining the hand geometry comprises: means for obtaining a first and second feature of the hand; and means for measuring a distance from the first feature to the second feature.

In Example 35, the subject matter of Example 34 optionally includes wherein the first feature is a base of a first finger and the second feature is a base of second finger of the hand.

In Example 36, the subject matter of any one or more of Examples 34-35 optionally include wherein the first feature is a base of a finger and the second feature is a tip of the finger.

In Example 37, the subject matter of any one or more of Examples 31-36 optionally include wherein the means for determining the hand geometry comprises: means for creating a three-dimensional model of the hand based on a plurality of images from the image data; and means for estimating a volume of at least a portion of the three-dimensional model of the hand, wherein the hand geometry includes the volume.

In Example 38, the subject matter of Example 37 optionally includes wherein the volume is a volume of a finger of the hand.

In Example 39, the subject matter of any one or more of Examples 37-38 optionally include wherein the volume is a volume of the entire hand.

In Example 40, the subject matter of any one or more of Examples 31-39 optionally include wherein the means for determining the palm print comprises: means for identifying a palm portion of the hand; means for identifying a crease in the palm portion; and means for capturing a shape defined by the crease.

In Example 41, the subject matter of any one or more of Examples 31-40 optionally include wherein the means for determining the gesture performed by the hand comprises: means for obtaining a movement of the hand over time using a series of images from the image data; and means for using a classifier to identify the gesture.

In Example 42, the subject matter of any one or more of Examples 31-41 optionally include wherein the means for determining the bio-behavioral movement sequence performed by the hand comprises: means for accessing a series of images from the image data, the series of images depicting movement over time of the hand; means for identifying a pattern of behavior exhibited in the series of images; and means for storing the pattern as the bio-behavioral movement sequence.

In Example 43, the subject matter of Example 42 optionally includes wherein the pattern of behavior comprises subconscious movement performed by the user.

In Example 44, the subject matter of any one or more of Examples 31-43 optionally include means for using the user biometric template to authenticate the user.

Example 45 is at least one machine-readable medium including instructions for multi-modal user authentication, which when executed by a machine, cause the machine to: access image data captured by a camera array, the image data including a hand of a user; determine a hand geometry of the hand based on the image data; determine a palm print of the hand based on the image data; determine a gesture performed by the hand based on the image data; determine a bio-behavioral movement sequence performed by the hand based on the image data; and construct a user biometric template using the hand geometry, palm print, gesture, and bio-behavioral movement sequence.

In Example 46, the subject matter of Example 45 optionally includes wherein the image data includes a composition of infrared imagery and visible light imagery.

In Example 47, the subject matter of any one or more of Examples 45-46 optionally include wherein the camera array comprises an infrared camera and a visible light camera, and wherein the infrared imagery and visible light imagery of the image data are synchronized in the time and space domain.

In Example 48, the subject matter of any one or more of Examples 45-47 optionally include wherein the instructions to determine the hand geometry comprise instructions to: obtain a first and second feature of the hand; and measure a distance from the first feature to the second feature.

In Example 49, the subject matter of Example 48 optionally includes wherein the first feature is a base of a first finger and the second feature is a base of second finger of the hand.

In Example 50, the subject matter of any one or more of Examples 48-49 optionally include wherein the first feature is a base of a finger and the second feature is a tip of the finger.

In Example 51, the subject matter of any one or more of Examples 45-50 optionally include wherein the instructions to determine the hand geometry comprise instructions to: create a three-dimensional model of the hand based on a plurality of images from the image data; and estimate a volume of at least a portion of the three-dimensional model of the hand, wherein the hand geometry includes the volume.

In Example 52, the subject matter of Example 51 optionally includes wherein the volume is a volume of a finger of the hand.

In Example 53, the subject matter of any one or more of Examples 51-52 optionally include wherein the volume is a volume of the entire hand.

In Example 54, the subject matter of any one or more of Examples 45-53 optionally include wherein the instructions to determine the palm print comprise instructions to: identify a palm portion of the hand; identify a crease in the palm portion; and capture a shape defined by the crease.

In Example 55, the subject matter of any one or more of Examples 45-54 optionally include wherein the instructions to determine the gesture performed by the hand comprise instructions to: obtain a movement of the hand over time using a series of images from the image data; and use a classifier to identify the gesture.

In Example 56, the subject matter of any one or more of Examples 45-55 optionally include wherein the instructions to determine the bio-behavioral movement sequence performed by the hand comprise instructions to: access a series of images from the image data, the series of images depicting movement over time of the hand; identify a pattern of behavior exhibited in the series of images; and store the pattern as the bio-behavioral movement sequence.

In Example 57, the subject matter of Example 56 optionally includes wherein the pattern of behavior comprises subconscious movement performed by the user.

In Example 58, the subject matter of any one or more of Examples 45-57 optionally include instructions to use the user biometric template to authenticate the user.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An authentication system for multi-modal user authentication, the system comprising:
a memory including image data captured by a camera array, the image data including a hand of a user; and
an image processor to:
determine a hand geometry of the hand based on the image data;
determine a palm print of the hand based on the image data;
determine a gesture performed by the hand based on the image data; and
determine a bio-behavioral movement sequence performed by the hand based on the image data; and
an authentication module to construct a user biometric template using the hand geometry, palm print, gesture, and bio-behavioral movement sequence.

2. The system of claim 1, wherein the image data includes a composition of infrared imagery and visible light imagery.

3. The system of claim 1, wherein the camera array comprises an infrared camera and a visible light camera, and wherein the infrared imagery and visible light imagery of the image data are synchronized in the time and space domain.

4. The system of claim 1, wherein to determine the hand geometry, the image processor is to:
obtain a first and second feature of the hand; and
measure a distance from the first feature to the second feature.

5. The system of claim 4, wherein the first feature is a base of a first finger and the second feature is a base of second finger of the hand.

6. The system of claim 4, wherein the first feature is a base of a finger and the second feature is a tip of the finger.

7. The system of claim 1, wherein to determine the hand geometry, the image processor is to:
create a three-dimensional model of the hand based on a plurality of images from the image data; and
estimate a volume of at least a portion of the three-dimensional model of the hand, wherein the hand geometry includes the volume.

8. The system of claim 7, wherein the volume is a volume of a finger of the hand.

9. The system of claim 7, wherein the volume is a volume of the entire hand.

10. The system of claim 1, wherein to determine the palm print, the image processor is to:
identify a palm portion of the hand;
identify a crease in the palm portion; and
capture a shape defined by the crease.

11. The system of claim 1, wherein to determine the gesture performed by the hand, the image processor is to:
obtain a movement of the hand over time using a series of images from the image data; and
use a classifier to identify the gesture.

12. The system of claim 1, wherein to determine the bio-behavioral movement sequence performed by the hand, the image processor is to:
access a series of images from the image data, the series of images depicting movement over time of the hand;
identify a pattern of behavior exhibited in the series of images; and
store the pattern as the bio-behavioral movement sequence.

13. The system of claim 12, wherein the pattern of behavior comprises subconscious movement performed by the user.

14. The system of claim 1, wherein the authentication module is to use the user biometric template to authenticate the user.

15. A method of multi-modal user authentication, the method comprising:
accessing image data captured by a camera array, the image data including a hand of a user;
determining a hand geometry of the hand based on the image data;
determining a palm print of the hand based on the image data;
determining a gesture performed by the hand based on the image data;
determining a bio-behavioral movement sequence performed by the hand based on the image data; and
constructing a user biometric template using the hand geometry, palm print, gesture, and bio-behavioral movement sequence.

16. The method of claim 15, wherein the image data includes a composition of infrared imagery and visible light imagery.

17. The method of claim 15, wherein the camera array comprises an infrared camera and a visible light camera, and wherein the infrared imagery and visible light imagery of the image data are synchronized in the time and space domain.

18. The method of claim 15, wherein determining the hand geometry comprises:
obtaining a first and second feature of the hand; and
measuring a distance from the first feature to the second feature.

19. The method of claim 18, wherein the first feature is a base of a first finger and the second feature is a base of second finger of the hand.

20. The method of claim 18, wherein the first feature is a base of a finger and the second feature is a tip of the finger.

21. The method of claim 15, wherein determining the hand geometry comprises:
creating a three-dimensional model of the hand based on a plurality of images from the image data; and
estimating a volume of at least a portion of the three-dimensional model of the hand, wherein the hand geometry includes the volume.

22. At least one machine-readable medium including instructions for multi-modal user authentication, which when executed by a machine, cause the machine to:
access image data captured by a camera array, the image data including a hand of a user;
determine a hand geometry of the hand based on the image data;
determine a palm print of the hand based on the image data;
determine a gesture performed by the hand based on the image data;
determine a bio-behavioral movement sequence performed by the hand based on the image data; and
construct a user biometric template using the hand geometry, palm print, gesture, and bio-behavioral movement sequence.

23. The machine-readable medium of claim 22, wherein the instructions to determine the gesture performed by the hand comprise instructions to:
obtain a movement of the hand over time using a series of images from the image data; and
use a classifier to identify the gesture.

24. The machine-readable medium of claim 22, wherein the instructions to determine the bio-behavioral movement sequence performed by the hand comprise instructions to:
access a series of images from the image data, the series of images depicting movement over time of the hand;
identify a pattern of behavior exhibited in the series of images; and
store the pattern as the bio-behavioral movement sequence.

25. The machine-readable medium of claim 24, wherein the pattern of behavior comprises subconscious movement performed by the user.
